(19) United States
(12) Patent Application Publication
(10) Pub. No.: US 2008/0289973 A1
(43) Pub. Date: Nov. 27, 2008

(54) APPARATUS, SYSTEMS AND METHODS FOR TRACKING DRUG ADMINISTRATION

(76) Inventor: Ronald R. MacLeod, Mississauga (CA)

Correspondence Address: HERMAN & MILLMAN, 141 ADELAIDE ST. WEST, SUITE 1002, TORONTO, ON, M5H 3L5, CA

(21) Appl. No.: 11/753,257

(22) Filed: May 24, 2007

(51) Int. Cl. A45C 11/00; G08B 13/14

(52) U.S. Cl. 206/81; 340/572.1

(57) ABSTRACT

According to aspects of the invention provided are apparatus, systems and methods for monitoring the presence/absence of syringes within a storage unit and monitoring the amount of drugs that are discharged from syringes when they are not within the storage unit. Monitoring the presence/absence of syringes within the storage unit is accomplished using a combination of imaging sensors and a RFID tag reader. The method includes detecting and decoding signals from RFID tags to determine which syringes are present/absent from the storage unit and the times at which syringes are removed and returned to the storage unit The method also includes collecting visual information with respect to when syringes are removed and returned to the storage unit. The timing information from the RFID reader and the imaging sensors are compared to resolve the identification of syringes. Once the timing information from the RFID reader and the imaging sensors is resolved so as to identify specific syringes, the visual information can be used to calculate the amount of a drug discharged from each syringe.

### FIELD OF THE INVENTION

The invention relates to patient care; and in particular to apparatus, systems and methods for tracking drug administration at a point of care.

### BACKGROUND OF THE INVENTION

Preferred practices are often codified as standard operating procedures that health-care professionals are mandated to follow. However, strict adherence to standard operating procedures by health-care professionals is difficult to monitor and enforce because in many situations the professionals involved are self-monitoring and adherence to the standard operating procedures is solely in their control. This lack of monitoring may lead to human errors that have devastating consequences for a patient at the point of care.

An example of a point of care that is especially difficult to monitor is the operating theater (i.e. operating room) where anesthesiologists and nurses are responsible for administering various drugs during an operation (sometimes referred to as a case) The drugs have typically been transferred to a set of syringes that are labeled and placed on a table near the injection site on the patient. Specific drugs are delivered at corresponding times depending on the type of operation and the syringes are placed back on the table. After each drug is administered, the professional responsible for administering the drug is supposed to record the time and dosage provided to the patient. This practice is flawed because it is not possible to determine if the professional has correctly administered the drug and accurately recorded the administration or followed preferred practices with respect to syringes.

Health-care professionals, especially operating-room staff, are naturally cautious and risk averse when contemplating the adoption of new operating procedures and/or electronic systems that involve significant changes to their accepted standard preferred practices. Despite this, human-error and its effects are precluded from being reduced by not adopting a more systematic method for recording and monitoring the administration of drugs at a point of care.

### SUMMARY OF THE INVENTION

According to an aspect of an embodiment of the invention, there is provided a storage unit which includes: a housing having base and top walls and at least one side wall extending between the base and the top walls defining an enclosure, the walls including a material suitable for providing Radio Frequency (RF) energy isolation within the enclosure, and the top wall having at least one aperture for receiving a syringe; a radio frequency identification (RFID) tag reader within the enclosure for detecting and decoding signals from RFID tags within the enclosure; at least one imaging sensor for collecting visual information within the enclosure; and a control unit for managing the operation of the RFID tag reader and the imaging sensors.

In some embodiments, the storage unit also includes at least one inner dividing wall for defining at least two chambers within the enclosure, each dividing w all made from a material suitable for permitting substantially free transmission of radio frequency signals therethrough, and each defined chamber provided for storage of one syringe; a corresponding aperture in the top wall of each chamber defined within the enclosure; and a corresponding imaging sensor within each chamber for collecting visual information within the enclosure. In some more specific embodiments also includes an inner intermediate wall proximate and parallel to the base wall for defining a reservoir chamber within the enclosure, the inner intermediate wall having a corresponding aperture directly under each aperture in the top wall for receiving the nozzle end of a syringe.

In some embodiments, the control unit also includes: a user operated control; a memory unit; a processor; and a computer program product including computer usable program code for monitoring the use of syringes, the computer usable program code including program instructions 5 for: monitoring the presence and absence of syringes using at least one imaging sensor and storing a corresponding first record of the presence and absence of syringes from the imaging sensor; monitoring the presence and absence of syringes using a combination of RFID tags and RFID tag reader, wherein each syringe is provided with a RFID tag with a unique identifier, and storing a corresponding second record of the presence and absence of syringes from the RFID tag reader; and processing the first and second records to produce a third record including matched recorded visual information of each syringe with the corresponding unique identifier on one of the RFID tags. In some more specific embodiments, the user operated control includes at least one of a pressure sensor, a keypad and a mouse.

In some embodiments, the control unit includes a data port for connecting the control unit to another device for uploading information from the control unit to the other device.

In some embodiments, at least one of the apertures is provided with an expandable ring and a displacement sensor coupled to the expandable ring to measure the change in size of the expandable ring when a syringe is placed in the aperture.

According to another aspect of an embodiment of the invention, there is provided a method for monitoring the use of syringes, including: monitoring the presence and absence of syringes using at least one imaging sensor and storing a corresponding first record of the presence and absence of syringes from the imaging sensor; monitoring the presence and absence of syringes using a combination of RFID tags and a RFID tag reader, wherein each syringe is provided with a RFID tag with a unique identifier, and storing a corresponding second record of the presence and absence of syringes from the RFID tag reader; and, processing the first and second records to produce a third record including matched recorded visual information of each syringe with the corresponding unique identifier on one of the RFID tags.

In some embodiments, the method also includes: calculating changes in content volume in each syringe using the visual information in the third record for each syringe; and providing a fourth record including the respective changes in content volume of each syringe.

In some embodiments, the method also includes accepting an input signal from a user to begin monitoring the presence and absence of syringes.

In some embodiments, the method also includes accepting an input signal from a user to stop monitoring the presence and absence of syringes.

In some embodiments, monitoring the presence and absence of syringes using an imaging sensor includes: intermittently polling the at least one imaging sensor to collect visual information; detecting changes in the visual information; and storing the visual information along with a time indicator only when a change in the visual information has been detected,

In some embodiments, monitoring the presence and absence of syringes using a combination of RFID tags and a RFID tag reader includes: intermittently polling the RFID tag reader to determine which syringes are present; detecting changes in the number of syringes present; and storing the unique identifier of each syringe previously not present or now absent along with a time indicator only when a change in the number of syringes present has been detected.

In some embodiments, the method also includes providing a user readable output of the monitored information from the at least one imaging sensor and the RFID tag reader,

According to yet another aspect of an embodiment of the invention, there is provided a system for monitoring the use of syringes, including: a storage unit including a housing having base and top walls and at least one side wall extending between the base and the top walls defining an enclosure, the walls including a material suitable for providing Radio Frequency (RF) energy isolation within the enclosure; and the top wall having at least one aperture for receiving a syringe, a RFID tag reader within the enclosure for detecting and decoding signals from RFID tags within the enclosure, at least one imaging sensor for collecting visual information within the enclosure, a control unit for managing the operation of the RFID tag reader and the imaging sensors; and a plurality of RFID tags embedded on labels suitable for use on syringes.

In some embodiments, the control unit comprises: a user operated control; a memory unit; a processor; and a computer program product including computer usable program code for monitoring the use of syringes, the computer usable program code including program instructions for: monitoring the presence and absence of syringes using at least one imaging sensor and storing a corresponding first record of the presence and absence of syringes from the imaging sensor; monitoring the presence and absence of syringes using a combination of RFID tags and the RFID tag reader, wherein each syringe is provided with a RFID tag with a unique identifier, and storing a corresponding second record of the presence and absence of syringes from the RFID tag reader: and processing the first and second records to produce a third record including matched recorded visual information of each syringe with the corresponding unique identifier on one of the RFID tags.

In some embodiments, the control unit further comprises a data connection suitable for connection to a computer.

Other aspects and features of the present invention will become apparent to those ordinarily skilled in the art, upon review of the following description of the specific embodiments of the invention.

### BRIEF DESCRIPTION OF THE DRAWINGS

For a better understanding of the present invention; and to show more clearly how it may be carried into effect, reference will now be made, by way of example, to the accompanying drawings, which illustrate aspects of embodiments of the present invention and in which:

FIG. 1 is a perspective view of a storage unit provided in accordance with aspects of the invention:

FIG. 2 is a cross-section view of the storage unit in FIG. 1 along line A-A;

FIG. 3 is a system view of the storage unit in FIG. 1;

FIG. 4 is a perspective view of a storage unit provided in accordance with other aspects of the invention;

FIG. 5 is a flow chart illustrating method steps for visually monitoring syringes provided in accordance with aspects of the invention;

FIG. 6 is a flow chart illustrating method steps for monitoring RFID tags corresponding to syringes provided in accordance with aspects of the invention;

FIG. 7 is a flow chart illustrating method steps for resolving the identification of syringes provided in accordance with aspects of the invention; and

FIG. 8 is a timing diagram provided to illustrate an example of how the identification of a syringe is determined in accordance with aspects of the invention.

### DETAILED DESCRIPTION OF THE INVENTION

Strict adherence to standard operating procedures by health-care professionals is difficult to monitor and enforce because in many situations the professionals involved are self-monitoring and adherence to the standard operating procedures is solely in their control. An example of a point of care that is especially difficult to monitor is the operating theater where anesthesiologists and nurses are responsible for administering various drugs during an operation After each drug is administered, the professional responsible for administering the drug is supposed to record the time and dosage provided to the patient. This practice is flawed because it is not possible to determine if the professional has correctly administered the drug and accurately recorded the information or administration steps or followed preferred practices with respect to syringes. For example, it is bad practice to leave the syringe dangling within an acceptor or stopcock located at the injection site for too long because of the hazards that are created. First, the nozzle of the syringe may break within the acceptor or stopcock located at the injection site on the patient, which is an unwanted nuisance during a surgery. Alternatively, the stopcock may be dragged out of the patient or itself break, either of which would lead to blood loss from the patient,

Health-care professionals, especially operating-room staff, are naturally cautious and risk averse when contemplating the adoption of new operating procedures and/or electronic systems that involve significant changes to their accepted standard preferred practices. Despite this, human error and its effects could be reduced by adopting a more systematic method for recording and monitoring the administration of drugs at a point of care.

In accordance with aspects of the invention apparatus, systems and methods are provided that may enable a more systematic method for recording and monitoring the administration of drugs at a point of care.

In some embodiments, an apparatus in the form of a storage unit is provided in accordance with aspects of the invention. In some embodiments, the storage unit includes at least one imaging sensor for collecting visual information about syringes within the storage unit, and at least one Radio Frequency Identification (RFID) tag reader for detecting and decoding information from RFID tags placed on corresponding syringes. In some embodiments, the outer walls of the storage unit include a material suitable for providing Radio Frequency (RF) energy isolation within the storage unit. By substantially limiting the RF energy to within the storage unit, the number of times RFID tags outside the storage unit are detected by the RFID tag reader will be reduced. That is, RF energy isolation is provided in some embodiments to reduce the number of false positives that are recorded by the RFID reader within the storage unit.

According to some aspects of the invention, a method is provided for monitoring the presence/absence of syringes within the storage unit and monitoring the amount of drugs that are discharged from syringes when they are not within the storage unit. According to some aspects of the invention, monitoring the presence/absence of syringes within the storage unit is accomplished using a combination of imaging sensors and a RFID tag reader. Each syringe is provided with a respective RFID tag having a unique identifier. The method includes detecting and decoding signals from RFID tags to determine which syringes are present/absent from the storage unit and the times at which syringes are removed and returned to the storage unit by detecting and decoding the signal from the RFID tags on the syringes. The method also includes collecting visual information with respect to when syringes are removed and returned to the storage unit. Since syringes can be identical in construction, the timing information from the RFID reader and the imaging sensors are compared to resolve the identification of syringes. Once the timing information from the RFID reader and the imaging sensors is resolved so as to identify specific syringes, the visual information can be used to calculate the amount of a drug discharged from each syringe. Moreover, in some embodiments, the diameter or radius of a syringe can be ascertained from a displacement sensor connected to measure the change of an expandable ring through which a syringe is inserted into the storage unit. The diameter or radius of the syringe can then be used by the software to determine the size, in terms of volume, of the syringe.

According to other aspect of the invention, a system is provided for monitoring the presence/absence of syringes within the storage unit and monitoring the amount of drugs that are discharged from syringes when they are not within the storage unit. In some embodiments, the system includes the aforementioned storage unit and a number of RFID tags embedded on labels suitable for use on syringes. In more specific embodiments, the system includes a computer program product including computer usable program code for monitoring the use of syringes in accordance with the aforementioned methods.

Aspects of the invention may be embodied in a number of forms. For example, various aspects of the invention can be embodied in a suitable combination of hardware, software and firmware In particular, some embodiments include, without limitation, entirely hardware, entirely software, entirely firmware or some suitable combination of hardware, software and firmware. In a preferred embodiment, the invention is implemented in a combination of hardware and firmware, which includes, but is not limited to firmware, resident software, microcode, etc.

Additionally and/or alternatively, aspects of the invention can be embodied in the form of a computer program product that is accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by, or in connection with, the instruction execution system, apparatus, or device,

A computer-readable medium can be an electronic, magnetic, optical, electromagnetic, infrared, or semiconductor system (or apparatus or device) or a propagation medium. Examples of a computer-readable medium include a semiconductor and/or solid-state memory, magnetic tape, a removable computer diskette, a random access memory (RAM), a read-only memory (ROM), a rigid magnetic disk and an optical disk. Current examples of optical disks include, without limitation, compact disk read only memory (CD-ROM), compact disk—read/write (CD-R/W) and DVD.

In accordance with aspects of the invention, a data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Additionally and/or alternatively, in accordance with aspects of the invention, a data processing system suitable for storing and/or executing program code will include at least one processor integrated with memory elements through a system bus.

Input/output (i.e. I/O devices)—including but not limited to keyboards, touch-pads, displays, pointing devices, etc.—can be coupled to the system either directly or through intervening I/0 controllers.

Network adapters may also be coupled to the system to enable communication between multiple data processing systems, remote printers, or storage devices through intervening private or public networks. Modems, cable modems and Ethernet cards are just a few of the currently available types of network adapters.

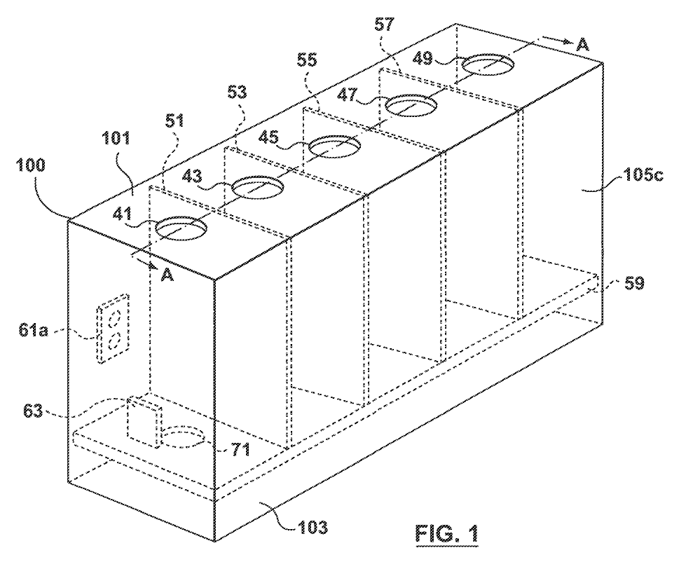

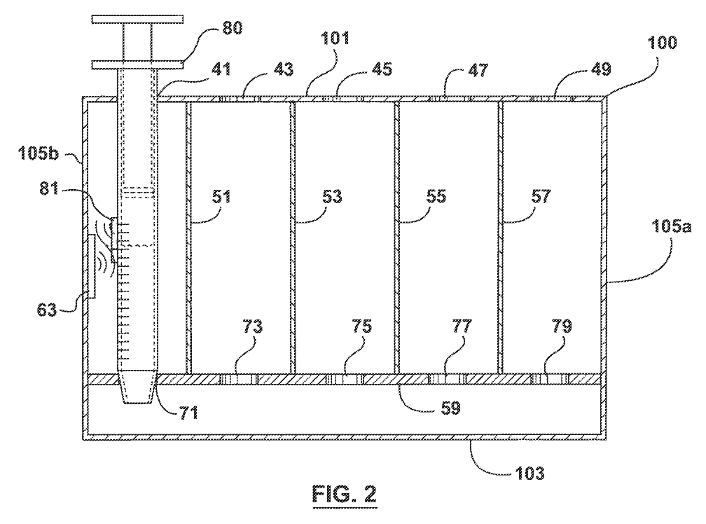

FIG. 1 shows a perspective view of a storage unit 100 provided in accordance with aspects of the invention, and FIG. 2 shows a cross-section view of the storage unit 100 along line A-A in FIG. 1. With reference to both FIGS. 1 and 2, the storage unit includes a housing having a top wall 101, a base wall 103 and walls 105a, 105b, 105c and 105d extending between the base wall 103 and the top wall 101 defining an enclosure. The walls 101, 103, and 105a-d of the housing are collectively referred to as outer walls of the storage unit 100 herein. The outer walls of the storage unit 100 include a material suitable for providing RF energy isolation within the enclosure. Examples of suitable materials include, without limitation, copper, aluminum, and conductive or semi-conductive ceramics. In some embodiments, the materials selected for the construction of the storage unit 100 are chosen because they can also be sterilized.

The storage unit 100 includes a RFID tag reader 63 within the enclosure for detecting and decoding signals from RFID tags within the enclosure. Specifically, in FIGS. 1 and 2, the RFID tag reader 63 is located within the enclosure on the outer wall 105b. The RFID tag reader 63 is suitable for detecting and decoding RFID signals within the storage unit 100. In some embodiments, the RFID tag reader 63 emits a RF signal within the storage unit capable of energizing RFID tags located with the storage unit 100 so as to invoke transmission from the RFID tags.

The enclosure within the storage unit 100 is divided into five syringe chambers by inner walls 51, 53, 55, and 57, where each chamber is provided for the storage of one syringe. For example, as shown in FIG. 2, a syringe 80 is located within one of the chambers defined in part by inner wall 51. Each of the dividing walls 51, 53, 55 and 57 are made from a material suitable for permitting substantially free transmission of radio frequency signals therethrough. The total number of chambers within a storage unit according to aspects of other embodiments may be higher or lower than the five provided in the illustrations of the storage unit 100. More generally, a storage unit may optionally have at least one inner dividing wall for defining at least two chambers within the enclosure, each dividing wall made from a material suitable for permitting substantially free transmission of radio frequency signals therethrough, and each defined chamber provided for storage of one syringe.

Each chamber is provided with a respective aperture in the top wall 101. In FIGS. 1 and 2, the five apertures included in the top wall 101 are labeled 41, 43, 45, 47 and 49. Each aperture 41, 43, 45, 47 and 49 is sized to permit the free entry of a syringe. In some embodiments, the apertures are different sizes. In other embodiments some of the apertures are variable so as to snuggly surround syringes of different sizes. In some embodiments, some of the apertures are also fitted with a respective expandable ring connected to a corresponding displacement sensor (not shown). The diameter or radius of a syringe can be ascertained from the respective displacement sensor connected to measure the change of a corresponding expandable ring through which a syringe is inserted into the storage unit 100. The diameter or radius of the syringe can then be used by the software to determine the size, in terms of volume, of the syringe.

Additionally, an inner wall 59 is provided at the bottom ends of the inner walls 51, 53, 55, and 57 and substantially parallel to the base wall 103 to define an optional reservoir chamber within the storage unit 100 for collecting drippings from syringes and preventing contamination of syringe nozzles. The inner wall 59 includes apertures 71, 73, 75, 77 and 79 for accepting the nozzle portion of syringes, as shown, for example only, in FIG. 2.

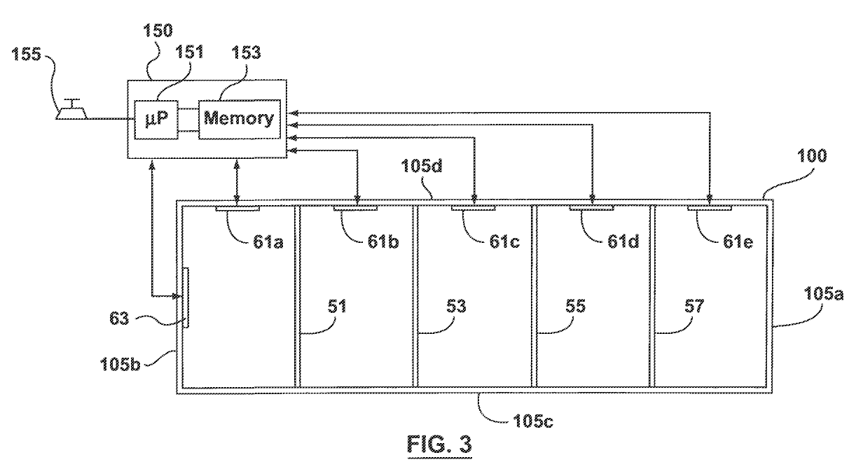

With further reference to FIG. 3, and continued reference to FIGS. 1 and 2, each chamber is provided with a respective an imaging sensor 61a, 61b, 61c, 61d and 61e. The imaging sensors 61a, 61b, 61c, 61d and 61e are provided to collect visual information from within each respective chamber. In general, the number of imaging sensors provided corresponds to the number of chambers provided, whereas a single RFID tag reader maybe sufficient for the entire storage unit 100, so long as the inner walls allow substantially free transmission of RF energy therethrough.

The system view of the storage unit 100 provided in FIG. 3 includes a control unit 150 that includes a user operated control 155, a memory unit 153, and a processor 151. The processor 151 includes a computer program product including computer usable program code for monitoring the use of syringes, the computer usable program code including program instructions for: monitoring the presence and absence of syringes using at least one imaging sensor and storing a corresponding first record of the presence and absence of syringes from the imaging sensor; monitoring the presence and absence of syringes using a combination of RFID tags and a RFID tag reader, wherein each syringe is provided with a RFID tag with a unique identifier, and storing a corresponding second record of the presence and absence of syringes from the RFID tag reader; and processing the first and second records to produce a third record including matched recorded visual information of each syringe with the corresponding unique identifier on one of the RFID tags.

In some embodiments, the user operated control 155 includes at least one of a pressure sensor, a keypad and a mouse.

In some other embodiments, the control unit 150 includes a data port (not specifically shown) for connecting the control unit to another device for uploading information from the control unit to the other device,

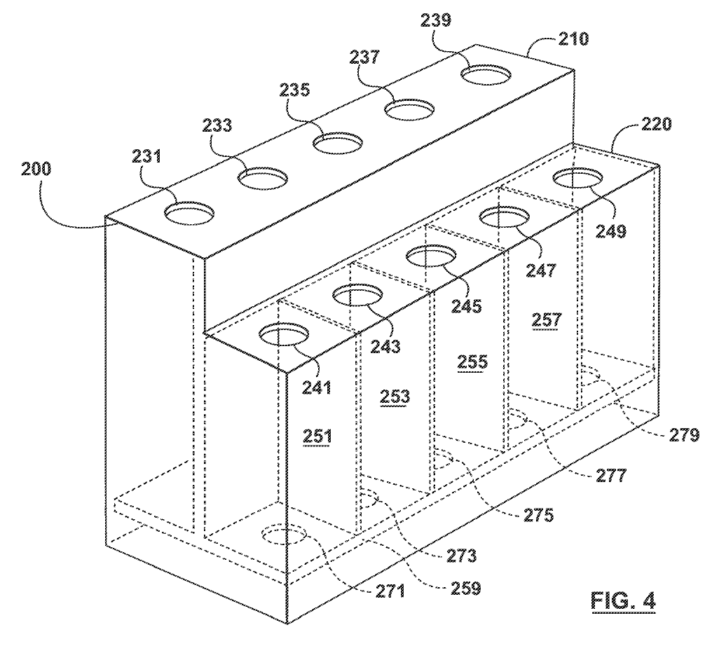

Turning to FIG. 4, shown is a perspective view of a storage 5 unit 200 provided in accordance with other aspects of the invention. The storage unit 200 includes two tiers, defined by first and second top walls 210 and 220; for separating two successive rows of syringe chambers. The first top wall 210 includes five apertures 231, 233, 235, 237 and 239 that are provided for five corresponding syringe chambers (not specifically shown). Similarly, the second top wall 220 also includes five apertures 241, 243, 245, 247 and 249 that are provided for five corresponding syringe chambers defined by inner walls 251; 253 and 255 and 257. The storage unit 200 also includes a inner wall 259 provided at the bottom ends of the inner walls 251, 253, 255, and 257 and substantially parallel to the base wall 203 to define an optional reservoir chamber within the storage unit 200 for collecting drippings from syringes and preventing contamination of syringe nozzles The inner wall 259 includes apertures 271, 273, 275, 277 and 279 for accepting the nozzle portion of syringes. The configuration of the storage unit 200 illustrated in FIG. 4 is provided as a specific example only, and is not meant to limit the scope of the claims.

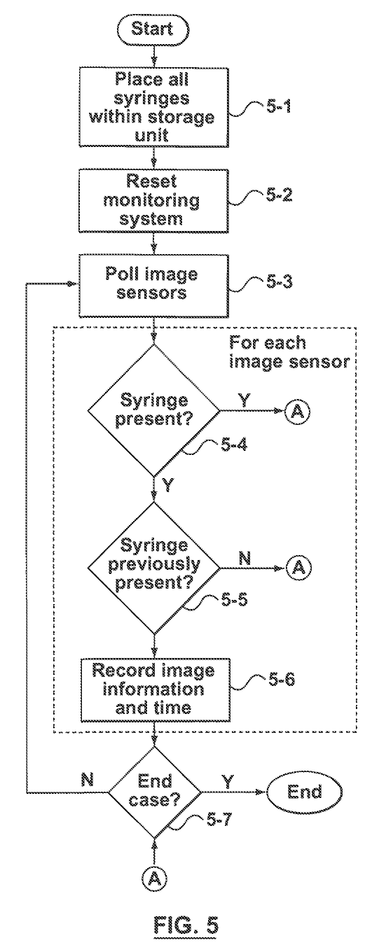

FIG. 5 is a flow chart illustrating the method steps of visually monitoring syringes provided in accordance with aspects of the invention. Starting at step 5-1, the method includes placing syringes within a storage unit provided in accordance with aspects of the invention, for example as described above with reference to FIGS. 14. Step 5-2 of the method includes reseting the monitoring system to clear spurious information that may have been collected by imaging sensors and provide an initial reading of which imaging sensors are starting out with syringes in front of them and which syringe chambers are empty. Step 5-3 includes polling the imaging sensors within the storage unit to collect visual information.

Steps 5-4 to 5-6 are specific for each imaging sensor and are meant to be repeated for each imaging sensor included in the storage unit. At step 5-4 the method includes determining if a syringe is present from the visual information collected by a particular imaging sensor. If no syringe is present (no path, step 5-4), the method moves onto to step 5-7, which is described below. If a syringe is present (yes path, step 5-4), the method moves onto step 5-5. At step 5-5 the method includes determining if a syringe was previously present the last time the imaging sensor was polled. If a syringe was present (yes path, step 5-5), the method moves onto step 5-7, as this is interpreted as an indication that there has not been a change within the syringe chamber the imaging sensor is arranged to monitor. If a syringe was not previously present (no path, step 5-5), then the method moves onto step 5-6. At step 5-6, the method includes recording image information and the time. The image information includes sufficient information to determine the diameter of a syringe and fluid level within the syringe.

At step 5-7 the method includes determining if the case is over. This may be determined by sensing an input from the user indicating to the controller that monitoring of the syringe chambers should stop. If the case is over (yes path, step 5-7), then the method ends. If the case is not over (no path, step 5-7), the method loops back to step 5-3 where the imaging sensors are again polled. According to some aspects of the invention, the time between polling the imaging sensors is between half a second and one second. Those skilled in the art will appreciate that a shorter duration is possible without adversely affecting the operation of the method. However, a longer duration between polling imaging sensors may result in lost information.

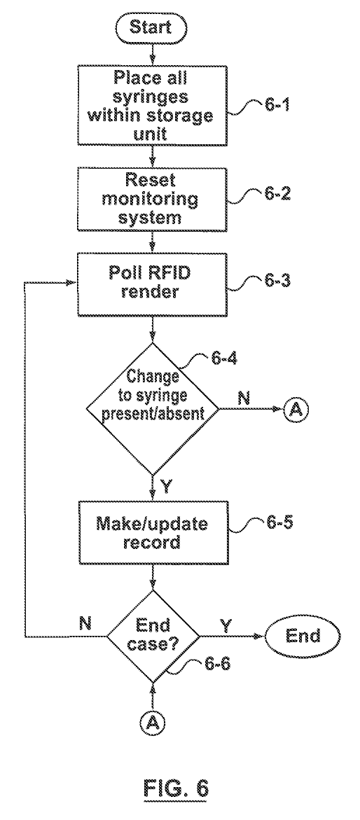

FIG. 6 is a flow chart illustrating the method steps of monitoring RFID tags corresponding to syringes provided in accordance with aspects of the invention. Starting at step 6-1, the method includes placing syringes within a storage unit provided in accordance with aspects of the invention, for example as described above with reference to FIGS. 1-4. Step 6-2 of the method includes reseting the monitoring system to clear spurious information that may have been collected by RFID tag reader and provide an initial reading of which RFID tags are within the storage unit. Step 6-3 includes polling the RFID tag reader within the storage unit to collect RFID tag information.

At step 6-4 the method includes determining changes in the syringes present/absent within the storage unit If there is not a change in the syringes present/absent (no path, step 6-4), the method moves onto step 6-6, which is described below. If there is a change in the syringes present (yes path, step 6-4), the method moves onto step 6-5. At step 6-5, the method includes recording and/or updating the record of syringes present and the time at which each syringe was removed or returned to the storage unit according to the presence/absence of a respective RFID tag within the storage unit.

At step 6-6 the method includes determining if the case is over. This may be determined by sensing an input from the user indicating to the controller that monitoring of the syringe chambers should stop. If the case is over (yes path, step 6-6), then the method ends. If the case is not over (no path, step 6-6), the method loops back to step 6-3 where the RFID tag reader is again polled. According to some aspects of the invention, the time between polling the imaging sensors is between half a second and one second. Those skilled in the art will appreciate that a shorter duration is possible without adversely affecting the operation of the method. However, a longer duration between polling imaging sensors may result in lost information.

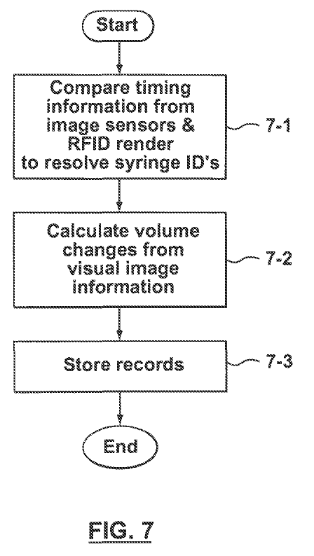

FIG. 7 is a flow chart illustrating method steps for resolving the identification of syringes provided in accordance with aspects of the invention. Starting at step 7-1, the method includes comparing the timing information corresponding to changes recorded by the imaging sensors and the RFID tag reader to determine the identification of syringes removed and returned to the storage unit without having to ensure that syringes are assigned specific syringe chambers. That is, by resolving the timing information, visual information at different times and in different syringe chambers of a particular syringe can be matched so as to enable the calculation of volume changes within that particular syringe. Moreover, those skilled in the art will appreciate that it is preferable that the polling of the RFID tag reader and the imaging sensor described above are synchronized in time.

Step 7-2 of the method includes calculating volume changes from the matched visual information for each syringe.

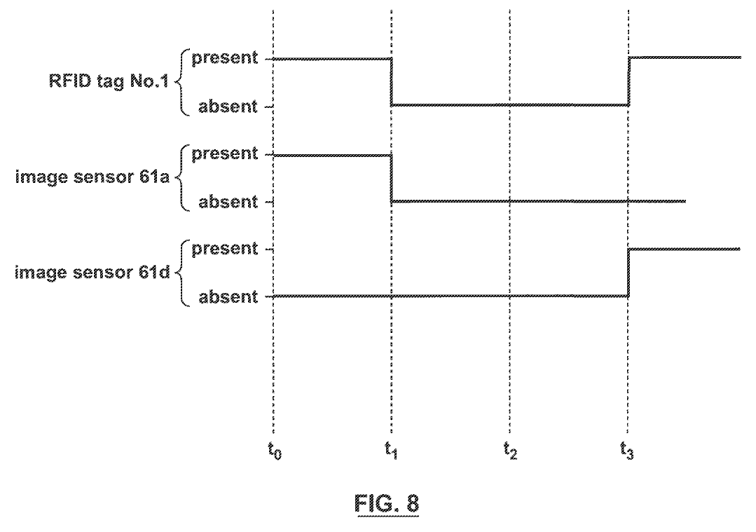

Referring to FIG. 8, shown is a timing diagram provided to illustrate an example of how the identification of a syringe is determined in accordance with aspects of the invention. The elements of the storage unit 100 shown in FIGS. 1-3 are referred to for convenience. At time t₀ a syringe with RFID tag No. 1 is present within the storage unit 100 and in front of imaging sensor 61a. At time t₁ the syringe with RFID tag No. 1 is removed from the storage unit 100 and the respective outputs of the RFID tag reader for RFID tag No. 1 and the imaging sensor 61a change from present to absent. At time t₃ the syringe with RFID No. 1 is returned, but is placed in the syringe chamber including imaging sensor 61d. As such, the respective outputs of the RFID tag reader for RFID tag No. 1 and the imaging sensor 61d change from absent to present, yet the output from imaging sensor 61a remains at absent. As such, if only visual information was available, trying to determine the volume changes in specific syringes would be difficult, especially when syringes are constructed identically. However, the presence of the RFID tags enable another method of identification that can be used to determine precisely which syringes are present and in which syringe chambers they are located.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention and numerous modifications and variations of the present invention are possible in light of the above disclosure.

1. A storage unit comprising:
a housing having base and top walls and at least one side wall extending between the base and the top walls defining an enclosure, the walls including a material suitable for providing Radio Frequency (RF) energy isolation within the enclosure, and the top wall having at least one aperture for receiving a syringe;
a radio frequency identification (RFID) tag reader within the enclosure for detecting and decoding signals from RFID tags within the enclosure;
at least one imaging sensor for collecting visual information within the enclosure; and
a control unit for managing the operation of the RFID tag reader and the imaging sensors.

2. A storage unit according to claim 1, further comprising:
at least one inner dividing wall for defining at least two chambers within the enclosure, each dividing wall made from a material suitable for permitting substantially free transmission of radio frequency signals therethrough, and each defined chamber provided for storage of one syringe;
a corresponding aperture in the top wall for each chamber defined within the enclosure: and
a corresponding imaging sensor within each chamber for collecting visual information within the enclosure.

3. A storage unit according to claim 2, further comprising an inner intermediate wall proximate and parallel to the base wall for defining a reservoir chamber within the enclosure, the inner intermediate wall having a corresponding aperture directly under each aperture in the top wall for receiving the nozzle end of a syringe.

4. A storage unit according to claim 1, wherein the control unit comprises:
a user operated control;
a memory unit;
a processor; and
a computer program product including computer usable program code for monitoring the use of syringes, the computer usable program code including program instructions for:
monitoring the presence and absence of syringes using at least one imaging sensor and storing a corresponding first record of the presence and absence of syringes from the imaging sensor;
monitoring the presence and absence of syringes using a combination of RFID tags and RFID tag reader, wherein each syringe is provided with a RFID tag with a unique identifier, and storing a corresponding second record of the presence and absence of syringes from the RFID tag reader; and
processing the first and second records to produce a third record including matched recorded visual information of each syringe with the corresponding unique identifier on one of the RFID tags.

5. A storage unit according to claim 4, where the user operated control includes at least one of a pressure sensor, a keypad and a mouse.

6. A storage unit according to claim 1, wherein the control unit includes a data port for connecting the control unit to another device for uploading information from the control unit to the other device.

7. A storage unit according to claim 3, wherein at least one of the apertures is provided with an expandable ring and a displacement sensor coupled to the expandable ring to measure the change in size of the expandable ring when a syringe is placed in the aperture.

8. A method for monitoring the use of syringes comprising:
monitoring the presence and absence of syringes using at least one imaging sensor and storing a corresponding first record of the presence and absence of syringes from the imaging sensor;
monitoring the presence and absence of syringes using a combination of Radio Frequency Identification (RFID) tags and a RFID tag reader, wherein each syringe is provided with a RFID tag with a unique identifier, and storing a corresponding second record of the presence and absence of syringes from the RFID tag reader; and
processing the first and second records to produce a third record including matched recorded visual information of each syringe with the corresponding unique identifier on one of the REID tags.

9. A method according to claim 8 further comprising:
calculating changes in content volume in each syringe using the visual information in the third record for each syringe; and
providing a fourth record including the respective changes in content volume of each syringe.

10. A method according to claim 8 further comprising accepting an input signal from a user to begin monitoring the presence and absence of syringes.

11. A method according to claim 8 further comprising accepting an input signal from a user to stop monitoring the presence and absence of syringes.

12. A method according to claim 8, wherein monitoring the presence and absence of syringes using an imaging sensor includes:
intermittently polling the at least one imaging sensor to collect visual information:
detecting changes in the visual information; and
storing the visual information along with a time indicator only when a change in the visual information has been detected.

13. A method according to claim 8, wherein monitoring the presence and absence of syringes using a combination if RFID tags and a RFID tag reader includes:
intermittently polling the RFID tag reader to determine which syringes are present;
detecting changes in the number of syringes present; and
storing the unique identifier of each syringe previously not present or now absent along with a time indicator only when a change in the number of syringes present has been detected.

14. A method according to claim 8 further comprising providing a user readable output of the monitored information from the at least one imaging sensor and the RFID tag reader.

15. A system for monitoring the use of syringes comprising:
a storage unit including a housing having base and top walls and at least one side wall extending between the base and the top walls defining an enclosure, the walls including a material suitable for providing Radio Frequency (RF) energy isolation within the enclosure, and the top wall having at least one aperture for receiving a syringe, a radio frequency identification (RFID) tag reader within the enclosure for detecting and decoding signals from RFID tags within the enclosure, at least one imaging sensor for collecting visual information within the enclosure, a control unit for managing the operation of the RFID tag reader and the imaging sensors; and
a plurality of RFID tags embedded on labels suitable for use on syringes.

16. A system according to claim 15, wherein the control unit comprises:
a user operated control;
a memory unit;
a processor; and
a computer program product including computer usable program code for monitoring the use of syringes, the computer usable program code including program instructions for:
monitoring the presence and absence of syringes using at least one imaging sensor and storing a corresponding first record of the presence and absence of syringes from the imaging sensor:
monitoring the presence and absence of syringes using a combination of RFID tags and RFID tag reader wherein each syringe is provided with a RFID tag with a unique identifier, and storing a corresponding second record of the presence and absence of syringes from the RFID tag reader; and
processing the first and second records to produce a third record including matched recorded visual information of each syringe with the corresponding unique identifier on one of the RFID tags.

17. A system according to claim 16, wherein the control unit further comprises a data connection suitable for connection to a computer.
